(19) United States
(12) Patent Application Publication
(10) Pub. No.: US 2026/0244652 A1
(43) Pub. Date: Aug. 20, 2026

(54) PREVENTING HALLUCINATIONS IN LANGUAGE MODELS BY MAPPING TO FACTS AS EXPLANATIONS

(71) Applicant: NEC Laboratories Europe GmbH, Heidelberg (DE)

(72) Inventors: Carolin LAWRENCE, Heidelberg (DE); Ammar SHAKER, Heidelberg (DE)

(21) Appl. No.: 19/104,381

(22) PCT Filed: Jun. 14, 2023
(86) PCT No.: PCT/IB2023/056119

§ 371 Date: Feb. 18, 2025

(30) Foreign Application Priority Data
Jan. 26, 2023 (EP) 23153495.9

(51) Int. Cl. G06F 16/332

(52) U.S. Cl. CPC G06F 16/3326

(57) ABSTRACT

A computer-implemented method for improving accuracy and reliability of a language model system includes encoding a query using a language model that has been pre-trained to generate responses to text queries and that has been further trained to adhere to retrieved facts for queries relating to a domain text. The retrieved facts are a subset of text chunks of the domain text. One or more relevant facts to the encoded query are retrieved based on the text chunks from the domain text. A response to the encoded query is generated using the retrieved relevant facts. Applications include, but are not limited to, use cases in material informatics, data security, cyberthreat intelligence, data extraction, digital transformation, and medical/healthcare.

### CROSS-REFERENCE TO PRIOR APPLICATIONS

This application is a U.S. National Phase application under 35 U.S.C. § 371 of International Application No. PCT/IB2023/056119, filed on Jun. 14, 2023, and claims benefit to European Patent Application No. EP 23153495, filed on Jan. 26, 2023, the entire contents of which is hereby incorporated by reference herein. The International Application was published in English on Aug. 2, 2024 as WO 2024/157059 A1 under PCT Article 21(2).

### FIELD

The present invention relates to artificial intelligence (AI) and machine learning, and in particular to a method, system and computer-readable medium for improving accuracy and preventing hallucinations of facts in language models.

### BACKGROUND

Language models, such as ChatGPT, have received an incredible amount of attention from both academia and businesses due to their impressive capabilities to produce fluent and convincing responses to human queries. However, too often these responses are factually incorrect, which is both deceiving and potentially harmful to users and downstream applications, and consequently makes it impossible to use such language models in many real world application settings. For example, Mok, Aaron, “Google's management has reportedly issued a ‘code red’ amid the rising popularity of the ChatGPT AI,” Business Insider, Tech, online (Dec. 21, 2022) cites that “ChatGPT is unable to fact-check what it says and can't distinguish between a verified fact and misinformation.” As an example, observe the below exchange between a human asking a question and a language model's (ChatGPT) reply:
Q (human user): Why Geoffrey Hinton couldn't win the Turing award?
A (language model): Geoffrey Hinton could not win the Turing award because it is not awarded posthumously. Hinton passed away in 2020, and the Turing award is only given to living individuals.

The reply of the language model (ChatGPT) is factually incorrect because, in fact, Geoffrey Hinton won the Turing award and he did not pass away in 2020. Even worse, the reply is formulated with complete confidence. Consequently, while a great academic milestone, the usage of such language models is dangerous in practical applications.

### SUMMARY

In an embodiment, the present invention provides a computer-implemented method for improving accuracy and reliability of a language model system. The method includes encoding a query using a language model that has been pre-trained to generate responses to text queries and that has been further trained to adhere to retrieved facts for queries relating to a domain text. The retrieved facts are a subset of text chunks of the domain text. One or more relevant facts to the encoded query are retrieved based on the text chunks from the domain text. A response to the encoded query is generated using the retrieved relevant facts.

Embodiments of the present invention can be used in a variety of applications, including but not limited to use cases in material informatics, data security, cyberthreat intelligence, data extraction, digital transformation, and medical/healthcare.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a method and system for improving the accuracy and reliability of a language model according to an embodiment of the present invention;

FIG. 2 schematically illustrates a training method and system architecture for training a language model, a fact retriever and a compression mechanism, and for generating a revised response of the language model according to an embodiment of the present invention; and

FIG. 3 is a block diagram of an exemplary processing system, which can be configured to perform any and all operations disclosed herein.

### DETAILED DESCRIPTION

Embodiments of the present invention provide to improve the accuracy and reliability of language models, and to increase confidence in their output, in particular by improving the computational functionality to build upon the ability to produce fluent responses, while overcoming the technical problem of hallucinating facts. Hallucinating facts refers to the response of the language model being factually incorrect and it being impossible for a human to discern this from the response alone. Consequently, embodiments of the present invention provide, by avoiding such hallucinations, improve the computational functionality of the language models to be more accurate and reliable, such that enhanced confidence in them also allows their use to provide improvements in a number of practical applications. In particular, embodiments of the present invention avoid hallucinating facts by first mapping to facts before producing a response.

Another example of a language model hallucinating fact hallucination is given by the following chat between a human user and a language model (ChatGPT).
Q (human user): Who is the CEO of Twitter?
A (language model): The CEO of Twitter is Elon Musk.
Q (human user): Since when?
A (language model): I apologize, my information is incorrect, Elon Musk is not the CEO of Twitter. My knowledge cut-off is 2021 and the current CEO of Twitter is Jack Dorsey as of 2021.
Q (human user): So, who is the CEO of Twitter?
A (language model): As of my knowledge cut-off in 2021, the CEO of Twitter was Jack Dorsey.
Q (human user): What about Elon Musk?
A (language model): Elon Musk is a business magnate, industrial designer, and engineer. He is the founder, CEO, and chief engineer/designer of SpaceX; early investor, CEO, and product architect of Tesla, Inc.; founder of the Boring Company; and co-founder of Neuralink. He was also co-founder and initial co-chairman of OpenAI. Elon Musk is not the CEO of Twitter.

The responses of the language model (ChatGPT) are problematic for two reasons. First, if the claim of ChatGPT's designers that it was trained with cut-off data in 2021 is true, the initial response would be factually incorrect since Elon Musk did not acquire Twitter before October of 2022. Second, if that claim is not true, then the language model has listened and learned from data beyond 2021. This, in fact, poses a serious technical problem in terms of data leakage, which poses a serious hazard to data privacy.

Accordingly, the current computational functionality of existing language model systems, such as ChatGPT, is not technically capable of avoiding hallucinations of fact and generating incorrect information, making such systems impractical or unusable for many higher risk applications, such as in medical AI, drug or treatment development, smart cities, public services, law enforcement, detecting risks to public safety, etc. The existing language model systems are especially dangerous when true facts are unknown and/or when the query is potentially dangerous, limiting their use to situations where a human can easily verify the response and factual correctness is less relevant. Moreover, many language models have a large size and are computationally expensive and burdensome to use. Embodiments of the present invention improve the language model systems by making them more accurate and reliable by helping to avoid hallucinations of fact, while at the same time providing for compression to ease the computational burden and save computational power and resources. This also provides to effect further improvements in a number of applications, especially higher risk applications, to which the language model systems heretofore could not be practically applied. Further, the advantages of language model systems, such as advancing and accelerating natural language processing applications, are further enhanced by the improved accuracy and reliability imparted by embodiments of the present invention.

According to a first aspect, the present invention provides a computer-implemented method for improving accuracy and reliability of a language model system. The method includes encoding a query using a language model that has been pre-trained to generate responses to text queries and that has been further trained to adhere to retrieved facts for queries relating to a domain text. The retrieved facts are a subset of text chunks of the domain text. One or more relevant facts to the encoded query are retrieved based on the text chunks from the domain text. A response to the encoded query is generated using the retrieved relevant facts.

According to a second aspect, the present invention provides the method according to the first aspect, wherein the relevant facts are retrieved by a fact retriever trained to extract one or more of the text chunks that are known to be valid, and/or that have a smaller distance to the encoded query and/or a higher attention relative to other ones of the text chunks.

According to a third aspect, the present invention provides the method according to the first or second aspects, wherein the fact retriever is a neural network trained to extract the one or more text chunks having the higher attention using a Gumbel-Softmax layer.

According to a fourth aspect, the present invention provides the method according to any of the first to third aspects, wherein the fact retriever is trained using an objective that brings the retrieved facts closer to corresponding ones of the queries.

According to a fifth aspect, the present invention provides the method according to any of the first to fourth aspects, further comprising generating an initial response to the encoded query using the language model, and using the initial response to retrieve the relevant facts.

According to a sixth aspect, the present invention provides the method according to any of the first to fifth aspects, further comprising verifying that the generated response does not contradict one of the retrieved relevant facts.

According to a seventh aspect, the present invention provides the method according to any of the first to sixth aspects, further comprising displaying to a user which of the text chunks of the domain text were used as the retrieved relevant facts for generating the response.

According to an eighth aspect, the present invention provides the method according to any of the first to seventh aspects, further comprising concatenating the generated response and the encoded query for generating additional text or a follow-up query.

According to a ninth aspect, the present invention provides the method according to any of the first to eighth aspects, wherein the language model is trained to adhere to the retrieved facts using an objective that increases a likelihood of the generated response with a constraint and/or an external reward.

According to a tenth aspect, the present invention provides the method according to any of the first to ninth aspects, wherein the constraint is directly incorporated into the language model to increase mutual information between the generated response and the retrieved relevant facts.

According to an eleventh aspect, the present invention provides the method according to any of the first to tenth aspects, wherein the external reward is used in a reinforcement learning-based training of the language model in which a penalty is based on a distance between the generated response and the retrieved relevant facts.

According to a twelfth aspect, the present invention provides the method according to any of the first to eleventh aspects, wherein the language model is trained to adhere to the retrieved facts by: encoding representations of each of the text chunks of the domain text, the queries relating to the domain text and responses from the language model; compressing the representations; retrieving the retrieved facts from the text chunks of the domain text for each of the queries using the compressed representations; and updating the language model using an objective that configures the language model to adhere to the retrieved facts.

According to a thirteenth aspect, the present invention provides the method according to any of the first to twelfth aspects, wherein the objective has the form of:

$${argmin}_{Θ} {E}_{{s}_{i} ∈ S} {E}_{{s}_{j} ∈ S ∖ \{ {s}_{i} \} , {q}_{r} ∈ Q ∖ \{ {q}_{i} \}} d ( {h}_{i} , {q}_{i} ) - {λ}_{1} d ( {h}_{j} , {q}_{i} ) - {λ}_{2} d ( {h}_{i} , {q}_{r} )$$

where Θ is the parametrization of the language model, S is the set of text chunks, sᵢ is a relevant text chunk, hᵢ is the encoded representation of the relevant text chunk, qᵢ is the corresponding query, sⱼ is a random chunk from the set of text chunks S, hⱼ is the encoded representation of the random chunk, qᵣ is a random query qᵣ, d is the distance measure in an embedding space, E is expectation to be minimized, and λ₁ and λ₂ are hyper-parameters to be fine-tuned.

According to a fourteenth aspect, the present invention provides a computer system for improving accuracy and reliability of a language model, the computer system comprising one or more hardware processors which, alone or in combination, are configured to provide for execution of the method according to any of the first to thirteenth aspects.

According to a fifteenth aspect, the present invention provides a tangible, non-transitory computer-readable medium having instructions thereon which, upon being executed by one or more processors, provide for execution of the method according to any of the first to thirteenth aspects.

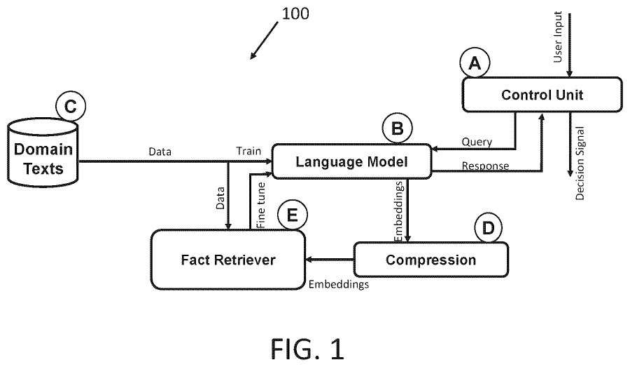

FIG. 1 schematically illustrates a method and system 100 for improving the accuracy and reliability of a language model B according to an embodiment of the present invention comprising a compression component D and a fact retriever E. The language model B, which is trained by data from a database of domain texts C, is iteratively fine-tuned using the compression of the representations of retrieved facts after receiving the user's query. A user interacts with the language model B via a control unit A that takes a user input, which can be used as, or used to generate, a query to the language model B. The language model B provides a response to the control unit A that can be used, or used to generate a decision signal as a response to the user input. For example, the user can utilize the response of the language model to perform a follow-up decision. In different applications, the user can also be another technical system or downstream application which utilizes the response or decision signal, for example, to generate automated decisions or actions for various machine learning tasks. The database of domain texts C includes all facts the language model B has access to. The compression component D is a module that compresses the representations of the query and related “facts” returned by the language model B. The fact retriever E is used for updating and fine-tuning the language model B.

According to an embodiment of the present invention, a method for improving the accuracy and reliability of a language model comprises the following steps:
compressing representations of a query to the language model and the response returned by the language model;
retrieving facts for the query; and
iteratively fine-tuning the language model using the retrieved facts.

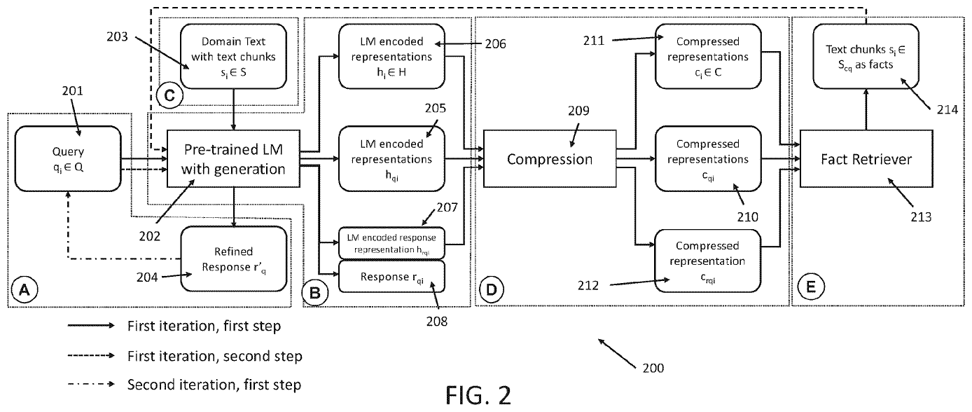

FIG. 2 schematically illustrates a system architecture 200 according to an embodiment of the present invention. A pre-trained language model (LM) with generation 202, which can be any existing or off-the-shelf LM that has been trained with any known technique and that is to be improved and further fine-tuned in accordance with an embodiment of the present invention, is further trained using as input domain text with text chunks sᵢ∈S 203, including all the text that the model can access as factual evidence for generation contained in the set of sentences sᵢ∈S. The LM provides for text generation through the creation of tokens that have the maximum probability, usually after a softmax operation. First, the domain text is split into text chunks, which can be, for example, sentences or paragraphs, but in this example are sentences sᵢ, and which are also referred to herein as contexts. Then each sentence sᵢ is encoded with the existing pre-trained LM with generation 202, resulting in LM encoded representations hᵢ∈H 206. For example, the encoding can be performed using multiple transformer blocks and multi-layer perceptron and attention heads of the LM. Inputting sentences into these blocks transfers the inputs into vectors in an embedding space. During generation, a subset of the sentences sᵢ is chosen to use as the factual basis for generating a response. Preferably, the subset of the sentences sᵢ is used rather than the entire set for space and memory constraints, and the subset can be chosen by a sampling technique. Therefore, a hidden representation hᵢ is stored for each sentence sᵢ that is chosen, which can be used in later steps. In many practical applications, the number of chunks and the size of the hidden representation hᵢ will be too large to easily store. For this reason, embodiments of the present invention employ a step of compression 209. This step reduces the size of the hidden representations hᵢ, producing compressed representations cᵢ∈C 211 of the chunks, while preserving semantic meaning and/or distance.

In addition, a set of queries qᵢ∈Q 201, each of which is associated with a corresponding response r_{q}_{ᵢ} 208 from the pre-trained LM with generation 202, are each encoded with the pre-trained LM with generation 202, resulting in LM encoded representations h_{q} 205. Additionally, the pre-trained LM with generation 202 also encodes the corresponding responses r_{q}_{ᵢ} 208 to produce the LM encoded representations h_{rq} 207. The LM encoded representations h_{q} 205 of the queries and the LM encoded representations h_{rg} 207 of the responses likewise undergo the step of compression 209 to produce the compressed representations c_{q} 210 of the queries and the compressed representations c_{rq} 212 of the responses, which along with the compressed representations cᵢ ∈C 211 of the chunks, serve as input to a fact retriever 213 according to an embodiment of the present invention, which outputs a set of text chunks sᵢ ∈S_{cq} 214. The set of text chunks sᵢ ∈S_{cq} 214 is input to the pre-trained LM with generation 202 such that the fact retriever 213 updates the parametrization of the LM with generation 202, in particular, so that the representations of the queries and their corresponding responses are close in the embedding space. For example, the fact retriever 213 solves the objective in option 2.b. below to update the parametrization of the LM with generation 202.

Accordingly, once all domain text is encoded and compressed, the training process iterates over the training set. For each instance, the following steps are performed:

1. Each query qᵢ 201 (for example, a question) is encoded with the pre-trained LM with generation 202 and the standard response the pre-trained LM with generation 202 gives are generated as response r_{q}_{ᵢ} 208, which may or may not be factual.

2. Next, both the hidden representation of the query, as the LM encoded representations h_{q} 205, as well as the hidden representation of the initial response, as the LM encoded response representation h_{rq} 207, undergo the step of compression 209. After that, a subset of text chunks sᵢ∈S_{cq} 214 are extracted by the fact retriever 213 as relevant facts. For this, the fact retriever 213 can take different shapes, for example:
a. The fact retriever 213 can be configured by training a neural network to retrieve a set of facts, for example, by learning an attention layer between the query/representation/joint concatenation and each text chunk (learning the linking between a query and the relevant text chunks) and then retrieving the chunks with highest attention, for example by sampling from Gumbel-Softmax. Applying the attention mechanism and Gumbel-Softmax can be performed according to known methods (see, e.g., Galassi, Andrea, et. al., “Attention in Natural Language Processing,” IEEE Transactions on Neural Networks and Learning Systems, Vol. 32, No. 10 (October 2021); and Jang, Eric, et. al., “Categorical Reparameterization with Gumbel-Softmax,” arXiv:1611.01144, ICLR (2017), each of which is hereby incorporated by reference herein).
b. The fact retriever 213 can be configured by mapping the representations of both the retrieved fact (text chunk on which the response is based) and the query to an invariant space. In the training data, it is known which facts correspond to which queries. The training and the objective minimization are iterated to provide the mapping, for each response, of the retrieved facts and the corresponding query. Assuming the parametrization of the language model to be noted as Θ, the aim is to fine-tune Θ under the restriction of bringing the respective LM encoded representation hᵢ and query q closer to each other compared to the query q and any other chunk sⱼ, where sᵢ is a valid fact for the query q. At the same time, this closeness should be smaller than that of a random query qᵣ, which cannot be answered by the valid fact sᵢ and its representation hᵢ. Concretely, the aim is to minimize the following objective:

$${argmin}_{Θ} {E}_{{s}_{i} ∈ S} {E}_{{s}_{j} ∈ S ∖ \{ {s}_{i} \} , {q}_{r} ∈ Q ∖ \{ {q}_{i} \}} d ( {h}_{i} , {q}_{i} ) - {λ}_{1} d ( {h}_{j} , {q}_{i} ) - {λ}_{2} d ( {h}_{i} , {q}_{r} )$$

where the first term tries to decrease the distance between the valid fact's representation hᵢ and the corresponding query qᵢ. The second term increases the distance between the query qᵢ and the representation of any random facts sⱼ∈S\{sᵢ}. Similarly, the third term increases the distance between any random query qᵣ and the representation hᵢ of the valid fact sᵢ; this term simulates the negative sampling in the space of queries. d is the distance measure in the embedding space. E is the mathematical notation for expectation. λ₁ and λ₂ are hyper-parameters that can be fine-tuned. The objective function updates the LM by trying to find the parametrization of the LM, denoted as Θ, that minimizes the expectation E.

Additionally or alternatively, the objective in option 2.b. can be implemented as a bi-level program with Θ in the master objective and the compression in the slave objective. These two objectives complement each other to achieve the min-max procedure defined above.

Additionally or alternatively, for the distance in the objective in option 2.b., another supervision signal (for example, from another AI system) can be employed that determines how likely it is that the chunk sᵢ answers the query qᵢ. The supervision signal can take a variety of different forms, for example depending on the type of other AI system, and indicates the determination in the other AI system of which facts are related to which queries.

Additionally or alternatively, for the distance in the objective in option 2.b. another supervision signal (for example, from another AI system) can be employed that determines how likely it is that the chunk sᵢ contradicts or disagrees with a particular response from the LM. As above, the supervision signal can take a variety of different forms, for example depending on the type of other AI system, and indicates the determination in the other AI system of which facts are related to which queries.

Additionally or alternatively, for the distance in the objective in option 2.b. another supervision signal (for example, from another AI system) can be employed that determines how likely it is that the chunk sᵢ contradicts or disagrees with a particular response from the LM given the query qᵢ. As above, the supervision signal can take a variety of different forms, for example depending on the type of other AI system, and indicates the determination in the other AI system of which facts are related to which queries.

Additionally or alternatively, for the distance in the objective in option 2.b., the distance of the query qᵢ is measured to each text chunk sᵢ and return all chunks sᵢ closer than a predetermined distance value d or the top k closest chunks are returned. The same procedure as described above could also be following, but using the initial response r_{q} as the basis. The query qᵢ and response r_{q} are concatenated, either as their hidden representations h_{q}, h_{rq} with a joint compression or by resending the concatenation through the language model, and then, as above, the objective is implemented as a bi-level program with Θ in the master objective and the compression in the slave objective, where these two objectives complement each other to achieve the min-max procedure defined above.

The above options may be combined into a single objective or used alternatingly to train the model of the fact retriever 213. This is particularly advantageous in cases where some supervision signals are cheaper or quicker to obtain than others. Overall, during training of the fact retriever 213, it is possible to either retrieve the currently closest facts to the query, and/or to directly use correct facts if this information is associated with the query-answer pairs.

Next, the query and extracted text chunks are concatenated. These can then be sent together through the pre-trained LM with generation 202 to generate a refined response r′_{q} 204, which is used as input to the pre-trained LM with generation 202 in a next iteration. In the concatenation, it is possible to mark the separate parts if so desired (for example, Query: q, Fact 1: s1, Fact 2: s2, . . . ). To make sure that the pre-trained LM with generation 202 adheres to the facts, the language model is updated using an objective that encourages this. This can be, for example, an objective that increases the maximum likelihood of the response with an additional constraint. This constraint is specifically applied to encourage generating a factual response based on both the query and facts, and can either be directly incorporated or an external reward estimation can be obtained indicating how much the newly generated response keeps the factuality based on the provided facts and utilize this in a reinforcement learning-based setup together with the likelihood of the generated response.

For both the additional constraint or the external reward, the following options can be used as examples:
The additional constraint could, for example, increase the mutual information between generated response and extracted facts. For example, the constraint can be to reduce the negative expected log of the conditional distribution q(Y|X) estimated by the model.
The additional constraint keeps the changes between the generated response and the underlying fact(s) minimal such that the larger the difference (for example, measured by token overlap) of the distance in the input space, the larger the penalty.
Natural language inference is used to check whether the generated response contradicts any of the facts. This can be implemented with machine learning techniques such as attention-based methods that detect a contradiction between a hypothesis and a given premise.

Different objectives can be combined either via linear combination or by iterating back and forth between different objectives.

According to embodiments of the present invention, different options for the step of compression 209 are possible, such as:
a. the identity function if the size of the representations doesn't have to be reduced.
b. a neural network that is learned end-to-end during the training process and is initially initialized at random, where the output dimension is smaller than the input dimension. This is done, for example, by adding linear layers where each layer has a number of outputs smaller than the number of inputs.
c. a locality-sensitive hash function.
d. any other dimensionality reduction technique.

At inference or prediction time, a query q is input to the language model further trained according an embodiment of the present invention and is asked to create a factual answer without any integration of imaginary or non-factual statements. To this end, the distance between the query q and each of the contexts sᵢ ∈S is measured. This can be the Euclidean distance measured in an embedding space of the encoded representations. The closest fact to the query is considered to be the most relevant one.

Embodiments of the present invention provide for the avoidance of producing statements that are irrelevant if an Oracle would not be able to answer the query despite the available contexts. For this avoidance, the following exemplary procedures could be used:
1. Heuristic-based rejection: Here, answering a query is rejected if the d(q, s*)>α σ, where

$$s *= arg {min}_{{s}_{i} ∈ s} d ( q , {s}_{i} ) ,$$

σ is standard deviation of the distances between all contexts, and α is an expert-chosen parameter that is domain specific.
2. Out-of-distribution detection of queries: Here, the free energy function of a query is defined as E(q;S,LM)=−log Σₛ_{ᵢ}_{∈S} exp(sᵢ⊙q), where ⊙ is the dot product between two vectors, and where the free energy function E(q; S, LM) is non-probabilistic (not normalized). From these energies, a simple rule is derived that discriminates between in-distribution and the out-distribution samples. This simple rule takes the form:

$$R ( q ; δ , LM ) = \{ \begin{matrix}{out}_{distribution} : & if E ( q ; S , LM ) \geq δ \\ {in}_{distribution} : & if E ( q ; S , LM ) < δ\end{matrix}$$

where δ is a threshold that is learned and tune from the already seen in-distribution quires.

If at least one of the contexts sᵢ∈ S is successfully retrieved, the at least one context (fact or set of facts that supports the correctness of the response) is used to generate the response (output of the LM system) and both the response and retrieved contexts are displayed to the user. In contrast to Sukhbaatar, S., et al., “End-to-End Memory Networks,” arXiv:1503.08895 (November 2015), which is hereby incorporated by reference herein and describe a probabilistic mixture of components, embodiments of the present invention ensure that a context is either retrieved or not retrieved.

Based on the retrieved facts, a new response is generated. The initial or new response can also be further fine-tuned using the retrieved facts. This response can only be returned, for example, where a natural language inference model does not detect any contradiction between the generated response and the retrieved facts. Optionally, an explainable AI (XAI) method can be used to highlight which tokens (words or syllables) in the query and contexts were used to generate which response tokens.

Embodiments of the present invention also provide for follow-up queries. In this case, the system may decide, for example, if an end of sequence symbol has not been generated or an externally set minimum response lengths has not been reached, to generate a longer response by re-running the process with the initial response as a prefix. Once the response is returned, the system may receive follow-up queries where the previous query and generated response can serve as a prefix to the new query.

Embodiments of the present invention can be practically applied to effect further improvements in a number of technical fields, which was heretofore not possible due to hallucinating of facts of existing language model systems. For example, embodiments of the present invention can be applied for document generation in fields such as public safety, smart cities, cyberthreat intelligence, or in medical AI fields such as for AI-assisted drug development, or for material design and development.

In a use case for document generation for knowledge work, the goal is, given an input document(s) and a query, generate the required documents, which can be, for example, a summary or an answer. The data source or “facts” for this use case are a set of input documents of interest, and the training data is a query or queries about these documents (for example, “Please summarize X”, “Did Hinton win the Turing award?”) and corresponding answer(s). According to application of the method according to an embodiment of the present invention, the input documents are used to create a set of concepts (retrieved facts/contexts/chunks). The query is then used to retrieve relevant concepts plus corresponding sentences. Based on this, the final response is generated. Thus, the output is a generated text that answers the query based on the facts retrieved from the input documents.

In a use case in medical AI for AI-assisted drug development or prescription, the goal is to automatically read published biomedical papers and derive a medical drug. The data source or “facts” for this use case are medical publications or reports, and the training data is a query or queries about these documents and corresponding answer(s). According to application of the method according to an embodiment of the present invention, a factual report is generated that summarizes and contrasts insights from several publications to answer a query. The query could be the description of a patient, the symptoms she the patient has and some medical tests. Thus, the output can be a personalized treatment recommendation or a report on which drug a particular patient should be given with underlying relevant facts, where a human may review the description and linked facts before approving to give the drug to the patient.

In a use case in material informatics, the goal is to automatically read material informatics papers or reports and derive a new material. The data source or “facts” include relevant publications or reports, and training data is a query or queries about these documents and corresponding answer(s). For example, for documents describing steel, a query could be “How to strengthen steel against corrosion?” According to application of the method according to an embodiment of the present invention, a factual report is generated that summarizes and contrasts insights from several publications to answer a query. Thus, the output can be a material design description with underlying relevant facts, where a human may review the description and linked facts before approving the production of the material.

In a use case in public safety, threat detection, law enforcement or government or corporate administration, the goal is to automatically read all relevant case files (for example, pertaining to one individual or to one topic of interest). The data source or “facts” for this use case include case files and related textual reports, and training data is a query or queries about these documents and corresponding answer(s). For example, if a document describes the security thread “denial of service”, exemplary queries could be “How does denial of service work?” or “What is the main damage caused by denial of service?” According to application of the method according to an embodiment of the present invention, a factual report is generated that summarizes and contrasts insights from the underlying case files to answer a query. Thus, the output can be a summarized report about the case files that answers the given query and, for example, allows to determine which category or benefits an individual should be assigned to.

In an embodiment, the present invention provides a method for producing factually correct responses from language models, the method comprising:
1) Collecting a domain text split into chunks that will serve as a fact base.
2) Collecting a set of queries and corresponding gold responses. For example, the gold responses could be created and checked manually by experts to ensure that and the other training from step 1) are correct.
3) Obtaining a pre-trained language model capable of generating textual responses.
4) Defining a process of how language model encoded representations can be compressed.
5) Language model encoding and compressing all domain text.
6) Training the language model, compression mechanism (if applicable) and fact retriever by:
   a. Encoding a query.
   b. Generating an initial response.
   c. Using the encoded query and initial response to retrieve relevant facts based on text chunks from the domain text.
   d. Using the encoded query and the retrieved relevant facts to produce a new response.
   e. Updating the language model, compression and fact retriever using an objective that encourages the final response as well as adhering to the facts extracted.
7) At inference, given a query, produce a response as follows:
   a. Encode the query.
   b. Generate initial response (optional).
   c. Implement a method that determines whether the system finds relevant facts.
   d. Use the encoded query and optionally the initial response to retrieve relevant facts based on text chunks from the domain text.
   e. Using the encoded query and the relevant facts to produce a refined response.
   f. Verify using, for example a natural language inference method, that the generated refined response does not contradict a relevant fact retrieved from the domain text.
   g. Implement a feature attribution explainable AI method that highlights which query and context tokens where used to generate a particular response token (optional).
8) The refined response can be concatenated to the query if additional text should be generated or a user poses follow up queries (optional).

Embodiments of the present invention provide for the following improvements over existing technology:
1. During inference or prediction time, for each query, a set of facts from a domain dataset (which is potentially private and can only be used in a certain environment), is retrieved and this is used to generate a factual response (see steps 1), 3), 4), 5) and 7) of the above method).
2. A supervision signal is provided for to identify suitable facts and these facts are used to produce a factual response (see steps 6)a.-c. of the above method), while ensuring that the refined response takes into consideration the retrieved facts by training the language model on an objective that takes the facts into account (see steps 6)d. and 6)e. of the above method).
3. Enabling to ensure that a response is only generated if at least one relevant fact is found (see step 7)c. of the above method).
4. Enabling to ensure that a generated response is only returned if it does not contradict a retrieved fact (see step 7)f. of the above method).
5. In contrast to existing language model systems, such as ChatGPT, the method and system according to embodiments of the present invention retrieves facts that are used to generate the final response. In this way, the chance to hallucinate an answer is explicitly reduced with the corresponding training procedure. Additionally, both the response and retrieved facts can be shown to human users, thus allowing them to run a check for themselves, and therefore greatly improving the safe use and applicability of such language model systems.
6. In contrast to WebGPT (see Nakano, R., et al., “WebGPT: Browser-assisted question-answering with human feedback,” arXiv 2112:09332 (June 2022), which is hereby incorporated by reference herein and describes to retrieve websites from a search engine before generating a response, the method and system according to embodiments of the present invention can operate on privately-owned data that is not part of the internet and does not require the use of a highly sophisticated search engine. Additionally, WebGPT does not have a training objective which encourages the generation of a factual response, instead relying on reinforcement learning to learn preferences which do not coincide with factuality (in contrast to improvement 2. listed above). Nor does WebGPT have a mechanism where the system declines to answer a query based on missing factual knowledge (in contrast to improvement 3. listed above).

In contrast to the end-to-end memory networks described by Sukhbaatar, S., the method and system according to embodiments of the present invention provides to overcome two technical limitations. In particular, unlike embodiments of the present invention, the end-to-end memory networks: (1) do not address the concept of hallucinations or the problem of how to prevent them (see improvements 2, and 3. listed above), and(2) assume a softmax distribution over the contexts, which makes it impossible to track how much each context influences the answer (in contrast to improvement 1. listed above). In an embodiment, the present invention explicitly either retrieves a context or not, thereby allowing humans to verify which information was used to generate a response.

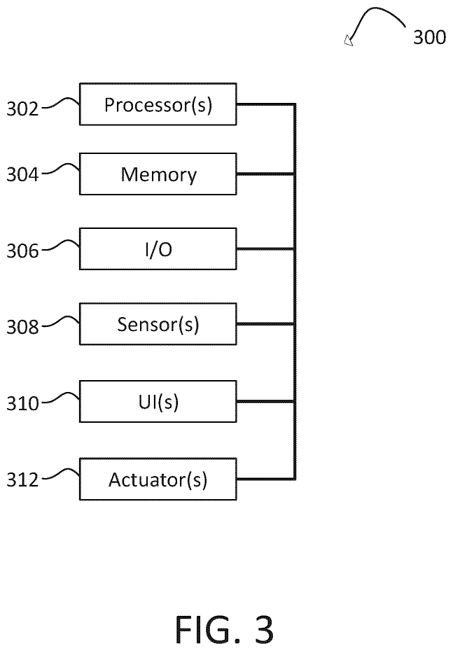

Referring to FIG. 3, a processing system 300 can include one or more processors 302, memory 304, one or more input/output devices 306, one or more sensors 308, one or more user interfaces 310, and one or more actuators 312. Processing system 300 can be representative of each computing system disclosed herein.

Processors 302 can include one or more distinct processors, each having one or more cores. Each of the distinct processors can have the same or different structure. Processors 302 can include one or more central processing units (CPUs), one or more graphics processing units (GPUs), circuitry (e.g., application specific integrated circuits (ASICs)), digital signal processors (DSPs), and the like. Processors 302 can be mounted to a common substrate or to multiple different substrates.

Processors 302 are configured to perform a certain function, method, or operation (e.g., are configured to provide for performance of a function, method, or operation) at least when one of the one or more of the distinct processors is capable of performing operations embodying the function, method, or operation. Processors 302 can perform operations embodying the function, method, or operation by, for example, executing code (e.g., interpreting scripts) stored on memory 304 and/or trafficking data through one or more ASICs. Processors 302, and thus processing system 300, can be configured to perform, automatically, any and all functions, methods, and operations disclosed herein. Therefore, processing system 300 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 300 can be configured to perform task “X”. Processing system 300 is configured to perform a function, method, or operation at least when processors 302 are configured to do the same.

Memory 304 can include volatile memory, non-volatile memory, and any other medium capable of storing data. Each of the volatile memory, non-volatile memory, and any other type of memory can include multiple different memory devices, located at multiple distinct locations and each having a different structure. Memory 304 can include remotely hosted (e.g., cloud) storage.

Examples of memory 304 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 304.

Input-output devices 306 can include any component for trafficking data such as ports, antennas (i.e., transceivers), printed conductive paths, and the like. Input-output devices 306 can enable wired communication via USB®, DisplayPort®, HDMI®, Ethernet, and the like. Input-output devices 306 can enable electronic, optical, magnetic, and holographic, communication with suitable memory 306. Input-output devices 306 can enable wireless communication via WiFi®, Bluetooth®, cellular (e.g., LTER, CDMA®, GSM®, WiMax®, NFC®), GPS, and the like. Input-output devices 306 can include wired and/or wireless communication pathways.

Sensors 308 can capture physical measurements of environment and report the same to processors 302. User interface 310 can include displays, physical buttons, speakers, microphones, keyboards, and the like. Actuators 312 can enable processors 302 to control mechanical forces.

Processing system 300 can be distributed. For example, some components of processing system 300 can reside in a remote hosted network service (e.g., a cloud computing environment) while other components of processing system 300 can reside in a local computing system. Processing system 300 can have a modular design where certain modules include a plurality of the features/functions shown in FIG. 3. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for improving accuracy and reliability of a language model system, the method comprising:
encoding a query using a language model that has been pre-trained to generate responses to text queries and that has been further trained to adhere to retrieved facts for queries relating to a domain text, the retrieved facts being a subset of text chunks of the domain text;
retrieving one or more relevant facts to the encoded query based on the text chunks from the domain text; and
generating a response to the encoded query using the retrieved relevant facts.

2. The computer-implemented method according to claim 1, wherein the relevant facts are retrieved by a fact retriever trained to extract one or more of the text chunks that are known to be valid, and/or that have a smaller distance to the encoded query and/or a higher attention relative to other ones of the text chunks.

3. The computer-implemented method according to claim 2, wherein the fact retriever is a neural network trained to extract the one or more text chunks having the higher attention using a Gumbel-Softmax layer.

4. The computer-implemented method according to claim 2, wherein the fact retriever is trained using an objective that brings the retrieved facts closer to corresponding ones of the queries.

5. The computer-implemented method according to claim 1, further comprising generating an initial response to the encoded query using the language model, and using the initial response to retrieve the relevant facts.

6. The computer-implemented method according to claim 1, further comprising verifying that the generated response does not contradict one of the retrieved relevant facts.

7. The computer-implemented method according to claim 1, further comprising displaying to a user which of the text chunks of the domain text were used as the retrieved relevant facts for generating the response.

8. The computer-implemented method according to claim 1, further comprising concatenating the generated response and the encoded query for generating additional text or a follow-up query.

9. The computer-implemented method according to claim 1, wherein the language model is trained to adhere to the retrieved facts using an objective that increases a likelihood of the generated response with a constraint and/or an external reward.

10. The computer-implemented method according to claim 9, wherein the constraint is directly incorporated into the language model to increase mutual information between the generated response and the retrieved relevant facts.

11. The computer-implemented method according to claim 9, wherein the external reward is used in a reinforcement learning-based training of the language model in which a penalty is based on a distance between the generated response and the retrieved relevant facts.

12. The computer-implemented method according to claim 1, wherein the language model is trained to adhere to the retrieved facts by:
encoding representations of each of the text chunks of the domain text, the queries relating to the domain text and responses from the language model;
compressing the representations;
retrieving the retrieved facts from the text chunks of the domain text for each of the queries using the compressed representations; and
updating the language model using an objective that configures the language model to adhere to the retrieved facts.

13. The computer-implemented method according to claim 1, wherein the objective has the form of:
$${argmin}_{Θ} {E}_{{s}_{i} ∈ S} {E}_{{s}_{j} ∈ S ∖ \{ {s}_{i} \} , {q}_{r} ∈ Q ∖ \{ {q}_{i} \}} d ( {h}_{i} , {q}_{i} ) - {λ}_{1} d ( {h}_{j} , {q}_{i} ) - {λ}_{2} d ( {h}_{i} , {q}_{r} )$$
where Θ is the parametrization of the language model, S is the set of text chunks, sᵢ is a relevant text chunk, hᵢ is the encoded representation of the relevant text chunk, qᵢ is the corresponding query, sⱼ is a random chunk from the set of text chunks S, hⱼ is the encoded representation of the random chunk, qᵣ is a random query qᵣ, d is the distance measure in an embedding space, E is expectation to be minimized, and λ₁ and λ₂ are hyper-parameters to be fine-tuned.

14. A computer system for improving accuracy and reliability of a language model, the computer system comprising one or more hardware processors which, alone or in combination, are configured to provide for execution of the following steps:
encoding a query using a language model that has been pre-trained to generate responses to text queries and that has been further trained to adhere to retrieved facts for queries relating to a domain text, the retrieved facts being a subset of text chunks of the domain text;
retrieving one or more relevant facts to the encoded query based on the text chunks from the domain text; and
generating a response to the encoded query using the retrieved relevant facts.

15. A tangible, non-transitory computer-readable medium having instructions thereon which, upon being executed by one or more processors, provide for execution of the following steps:
encoding a query using a language model that has been pre-trained to generate responses to text queries and that has been further trained to adhere to retrieved facts for queries relating to a domain text, the retrieved facts being a subset of text chunks of the domain text;
retrieving one or more relevant facts to the encoded query based on the text chunks from the domain text; and
generating a response to the encoded query using the retrieved relevant facts.
